(19) United States
(12) Patent Application Publication
(10) Pub. No.: US 2003/0202246 A1
(43) Pub. Date: Oct. 30, 2003

(54) Reduction of polarization dependence in optical systems

(76) Inventor: Roger Lee Jungerman, Petaluma, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/133,722

(22) Filed: Apr. 24, 2002

(51) Int. Cl. G02B 5/30

(52) U.S. Cl. 359/499; 359/494; 359/497

(57) ABSTRACT

Reduction of polarization dependence in optical systems. Polarization dependence is reduced by splitting an input signal into two halves spatially using a split-plate which bisects the optical beam. One half of the split-plate is a waveplate with a retardance of approximately ½ wave which rotates the signal 45 degrees with respect to the polarization axis. The other half of the split-plate is a delay plate which does not rotate the polarization state. Since half the beam is rotated orthogonal to the other half, the average of maximum and minimum polarization state signals will be observed.

### BACKGROUND OF THE INVENTION

1. Field of the Invention

The present invention pertains to the field of optical instruments and systems, and more specifically to methods for reducing polarization dependence in optical systems.

2. Art Background

Many optical systems suffer from signal variation based on the polarization state of the input signal. Examples include grating-based optical spectrometers (OSA) and optical systems using nonlinear optical wavelength conversion, including optical sampling systems. In such systems, performance is greatly dependent on the polarization of the input signal. In any system exhibiting polarization dependent loss (PDL) there is one axis which defines the polarization axis of the system. Input signals aligned along this axis produce maximum response, and inputs perpendicular to this axis produce minimum response.

### SUMMARY OF THE INVENTION

Polarization dependence in optical systems is reduced by splitting the input signal into two halves spatially using a split-plate which bisects the optical beam. One half of the split-plate is a waveplate which is oriented plane perpendicular to the incident beam with the optical axis of the waveplate oriented at 45 degrees with respect to the polarization axis. The waveplate has a retardance of approximately ½ wave, rotating the polarization of the optical beam 90 degrees. The other half of the split-plate is glass or other material which does not rotate the polarization state, but matches the delay of the waveplate.

### BRIEF DESCRIPTION OF THE DRAWINGS

The present invention is described with respect to particular exemplary embodiments thereof and reference is made to the drawings in which:

FIG. 1 shows a first view of an optical system, and

FIG. 2 shows a second view of an optical system.

### DETAILED DESCRIPTION

Many optical systems suffer from signal variation due to the polarization state of the input signal. Examples include grating based optical spectrometers (OSA) and optical systems using nonlinear optical wavelength conversion. This signal variation is usually called polarization dependent loss (PDL). In polarization dependent loss, there is one preferred polarization axis for the system. Input signals aligned with this axis produce maximum response. Signals with polarization perpendicular to this preferred axis produce minimum response.

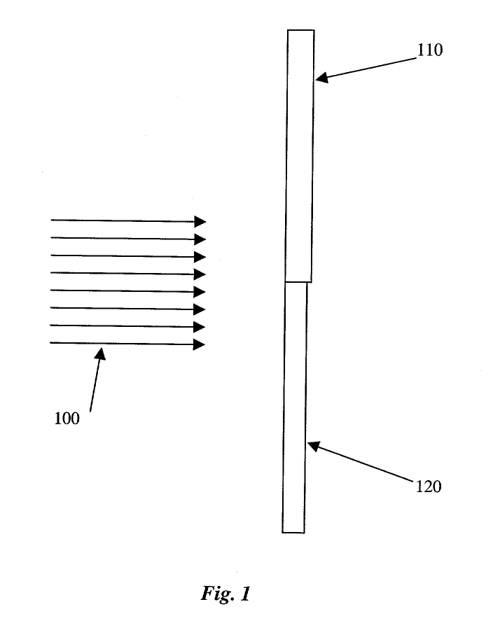

FIG. 1. shows an embodiment of the present invention. Input optical signal 100 is split into two halves spatially when the incident beam strikes the split-plate comprising waveplate 110 and delay plate 120. Waveplate 110 has a retardance of approximately ½ wave.

Waveplate 110 rotates the portion of input signal 100 incident upon it since the waveplate crystal axis is at 45 degrees to the input polarization axis. Since the angle of the polarization vector of a signal passing through a waveplate rotates by twice the waveplate angle, the portion of input signal 100 incident upon waveplate 110 is rotated 90 degrees.

Delay plate 120 does not alter the polarization state of the portion of input signal 100 incident upon it. Rather, delay plate 120 matches the time delay introduced into input signal 100 by waveplate 110. The matching of the time delay in the two halves 110 and 120 is achieved by choosing a glass type and thickness for delay plate 120 such that its time delay matches that of waveplate 110.

This optical delay compensation may be achieved over wider wavelength ranges by choosing several types of glass with varying chromatic dispersion to design a delay plate with the proper time correction over the desired wavelength range.

The requirements for delay plate 120 will depend on the application of the technique. In some systems, it is important that the total time delay through both halves of the plate is the same. For example, in an optical spectrum analyzer, the measured output in a system using a split-plate correction apparatus according to the present invention would show time dispersion induced by unequal delays between waveplate 110 and delay plate 120. Similarly, in an optical sampling system using very short optical pulses, it is important that the time delay difference between waveplate 110 and delay plate 120 be less than the optical pulse width.

Plates 110 and 120 should be joined together with a minimum gap. Half-waveplate 110 should be oriented in a plane perpendicular to the incident beam with the waveplate axis at 45 degrees to the polarization axis to insure the correct rotation of the polarization by the waveplate. The faces of waveplate 110 and delay plate 120 should be parallel to avoid deviation of the optical beam axis in passing through the plates. Waveplate 110 and delay plate 120 should be roughly coplanar, but if there is some deviation it will not significantly affect the operation so long as the assembly is oriented so that waveplate 110 is perpendicular to the incident beam.

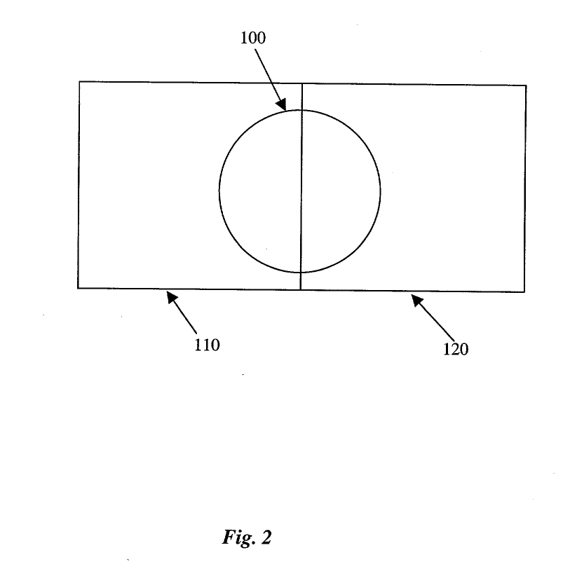

FIG. 2 shows a second view of the present invention. In operation, the polarization state of one half of input beam 100 is rotated 90 degrees, and one half of input beam 100 is not changed. If input signal 100 produces minimum efficiency in the optical system through one portion of the split plate assembly, then the other portion will produce maximum efficiency. Since the two halves of input beam 100 are orthogonally polarized, in all cases, including linear, unpolarized, or elliptically polarized inputs, the sum of both halves of the beam will give the same conversion efficiency, approximately 50%. Hence, independent of the polarization state of input beam 100, the average of maximum and minimum signals is observed.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. A compensator for placing in the path of an optical beam for compensating for polarization dependent loss in an optical device, the compensator comprising:
a waveplate bisecting the optical beam, and
a delay plate bisecting the optical beam.

2. The compensator of claim 1 where the waveplate rotates the polarization of the optical beam by 90 degrees.

3. The compensator of claim 1 where the delay plate has an optical time delay similar to that of the waveplate.

4. The compensator of claim 1 where the faces of the waveplate and the delay plate are parallel to each other.

5. The compensator of claim 1 where at least one face of the waveplate and the delay plate are coplanar.

6. The compensator of claim 1 where the waveplate is plane perpendicular to the optical beam.

7. The method for compensating for polarization dependent loss in an optical beam in an optical device, comprising:
rotating the polarization state of a first portion of the optical beam by 90 degrees using a waveplate, and
delaying a second portion of the optical beam by an amount similar to the delay introduced by the waveplate using a delay plate.

8. The method of claim 7 where the faces of the waveplate and the delay plate are parallel to each other.

9. The method of claim 7 where at least one face of the waveplate and the delay plate are coplanar.

10. The method of claim 7 where the waveplate is plane perpendicular to the optical beam.
